(19) United States
(12) Patent Application Publication
(10) Pub. No.: US 2010/0239960 A1
(43) Pub. Date: Sep. 23, 2010

(54) PRODUCTION METHOD FOR FUEL CELL SEPARATOR

(75) Inventors: Osamu Ishigami, Hagagun (JP); Mayu Takagi, Hagagun (JP); Mai Kondo, Hagagun (JP)

Correspondence Address: RANKIN, HILL & CLARK LLP, 38210 GLENN AVENUE, WILLOUGHBY, OH, 44094-7808, US

(73) Assignee: HONDA MOTOR CO., LTD., Tokyo (JP)

(21) Appl. No.: 12/726,667

(22) Filed: Mar. 18, 2010

(30) Foreign Application Priority Data
Mar. 23, 2009 (JP) 2009-069872

(51) Int. Cl. H01M 8/04

(52) U.S. Cl. 429/535

(57) ABSTRACT

The present invention provides a production method for fuel cell separator, including: preparing a material plate made of stainless steel; press forming the material plate, so that the material plate has a cross section having a concavo-convex shape; and plating only convex of the concavo-convex shape of the material plate with a conductive metal, wherein in the plating, a plating solution holding member, having a plating solution including an ion of the conductive metal, is prepared, the plating solution holding member contacts only the convex, and current is supplied between the solution holding member and the material plate, and in the plating, hydrogen is generated on a surface of the material plate, a passivation film formed on the surface of the material plate is reduced by the hydrogen, and the material plate is plated with the conductive metal.

### BACKGROUND OF THE INVENTION

1. Field of the Invention

The present invention relates to a production method for fuel cell separators. In particular, it relates to a technique for reduction of processes in a production method for separator made of stainless steel.

2. Description of Related Art

In fuel cells, separators are applied to both sides of a plate-shaped electrode (MEA: Membrane Electrode Assembly), so that a layered structure (cell) is formed as a unit. Plural units (for example, a few hundred of units) are stacked to form a fuel cell stack. The MEA is a three-layered structure that a polymerized electrolytic membrane, which is made of an ion-exchange resin or the like, is held by a pair of electrode plates which are positive electrode plate (air electrode, cathode) and negative electrode plate (fuel electrode, anode). In the fuel cell, for example, a fuel gas is supplied to a gas passage which faces a gas diffusion electrode plate at a side of the fuel electrode plate, and an oxidizing gas is supplied to a gas passage which faces a gas diffusion electrode plate at a side of the positive electrode plate, so that electricity is generated by electrochemical reaction.

A fuel cell separator requires a high conductivity. Thus, the fuel cell separator is made such that a carbon plate is subjected to cutting work and passages for gases and cooling media are formed. Alternatively, the fuel cell separator is made by press forming of metal plate. In particular, in recent years, fuel cells have been developed as an energy source for transportation means (for example, automobiles). In this condition, it is necessary that fuel cells may be compact, and metal separators have been developed so as to be more thinned.

In the reaction in the fuel cell, water is generated, and charge transfer in the polymerized electrolytic membrane is performed by proton (H⁺), so that the atmosphere in the fuel cell is an acidic atmosphere. Thus, when the metal separator is used, it is necessary to secure conductivity and corrosion resistance thereof. Stainless steel can be used as a metal material superior in corrosion resistance. However, a passivation film exists on a surface of stainless steel, so that stainless steel is not superior in conductivity. In order to solve this problem, WO publication No. WO2006/129806 has proposed the following technique. A concavo-convex is formed on a stainless steel plate by press forming, and a passivation film is uniformly formed by etching (acid treating) on the overall material (stainless steel plate) again. Then, a portion of the passivation film, which requires conductivity, is removed by mechanical polishing, and this portion is subjected to noble metal plating. When etching is not performed, coating is easily deposited at a defect of the passivation film generated by press forming or the like, and noble metal is deposited at the undesired portion.

However, in the technique disclosed in WO publication No. WO2006/129806 or the like, the etching, which is performed for the forming of the uniform passivation film again, is necessary, and the mechanical polishing for the removing of the portion, which is to be subjected to noble metal plating, is necessary. Due to this, many production equipments and much production time for the above processes are necessary.

### SUMMARY OF THE INVENTION

An object of the present invention is to provide a production method for fuel cell separators which do not require etching and mechanical polishing of the separators and in which production equipments and production time for the etching and the mechanical polishing can be reduced.

The inventors keenly studied on a technique that a conductive metal coating is formed on a separator by plating without etching and mechanical polishing. As a result, the inventors focused our attention on strike plating which is performed before plating in general. In the strike plating, high density current is flowed in diluted plating solution, and electrolysis of water occurs. Due to this, hydrogen is generated on a surface of stainless steel functioning as a negative electrode. In this case, the inventors have been repeatedly tested based on our hypothesis that hydrogen may contact the stainless steel and passivation film may be thereby reduced. As a result, the inventors have found that the passivation film is removed by the strike plating and conductive coating is deposited thereat.

A production method for fuel cell separator according to the present invention was made on the above findings. According to one aspect of the present invention, a production method for fuel cell separator includes: preparing a material plate made of stainless steel; press forming the material plate, so that the material plate has a cross section having a concavo-convex shape; and plating only convex of the concavo-convex shape of the material plate with a conductive metal, wherein in the plating, a plating solution holding member, which has a plating solution including an ion of the conductive metal, is prepared, the plating solution holding member contacts only the convex, and current is supplied between the solution holding member and the material plate, and in the plating, hydrogen is generated on a surface of the material plate, a passivation film formed on the surface of the material plate is reduced by the hydrogen, and the material plate is plated with the conductive metal.

In the production method for fuel cell separator, since the solution holding member contacts only the convex, the plating can be selectively performed on the convex. Thus, even when a defect exists on the passivation film due to the press forming, deposition of noble metal to an unnecessary portion other than the convex can be inhibited, so that etching, which was necessary in the conventional technique, can be omitted. Since the plating is performed in the condition that hydrogen is generated on the surface of the material plate, the reduction and removal of the passivation film can be simultaneously performed together with the plating. Thus, mechanical polishing, which was necessary in the conventional technique, can be omitted. Therefore, in the production method, processes can be shorter than in the conventional plating method, and production cost can be reduced. In order to improve the insulation property of the separator, if necessary, passivation film may be formed again by etching and heating before the plating. In this case, mechanical polishing can be unnecessary, so that production processes can be simplified.

According to one embodiment of the present invention, a structure of the solution holding member can be freely selected. For example, a roller, which is structured such that a porous material covers a surface of the roll made of a conductive material, can be used as the solution holding member. In this case, cloth, sponge, or rubber can be used as the porous material. Urethane or polyvinyl alcohol (PVA) can be used as a material of the sponge. Carbon, Ti—Pt alloy, Ti—Au alloy, a material in which Ir₂O₃ is dispersed in Ti, or the like can be used as a material of the roll. Plating solution may be impregnated into the porous material, and rollers may hold a surface and a rear surface of the material plate having the concavo-convex formed by the press forming. In this condition, current may be supplied to the roll and the material plate, and the roller may be rotated, so that the strike plating may be sequentially performed on all convexes of the concavo-convex. According to one embodiment of the present invention, a metal having corrosion resistance to acidic atmosphere in the fuel cell can be used as the conductive metal. For example, gold, platinum, or the like can be used as the conductive metal.

In metal separators, one surface of the separator may contacts a membrane electrode assembly, and another surface may be used for a passage for cooling water. In this case, it may be unnecessary to form a conductive metal coating on the another surface by plating, so that the plating solution may be impregnated into only the porous material of one roller, and current may be supplied between the roll thereof and the material plate.

A stamp, which is structured such that a porous material is provided on one surface of a flat plate made of a conductive material, can be used. The plating solution may be impregnated into the porous material, and stamps may hold a surface and a rear surface of the material plate having the concavo-convex. In this condition, current may be supplied to the flat plate and the material plate, so that the strike plating can be performed on all the convexes of the concavo-convex at one time. In this feature, the plating solution can be impregnated into only the porous material of one stamp, and current may be supplied between the stamp and the material plate.

A brush, which is structured such that bunchy coats are fixed at an end portion of shaft made of a conductive material, can be used. The plating solution may be impregnated into an end of the brush, the brush may contact the convex of the concavo-convex, and the current may be supplied to the shaft and the material plate, so that the strike plating can be performed on the convex of the concavo-convex.

According to the present invention, it is unnecessary to perform mechanical polishing on coating portion of the separator formed by plating, so that production equipments and production time for the mechanical polishing can be omitted, and adhesion of the separator with the coating can be improved without deterioration of surface characteristics of the separator.

### BRIEF DESCRIPTION OF THE DRAWINGS

FIGS. 1A to 1C are diagrams for explaining of main processes of one embodiment according to the present invention.

FIG. 2 is a side view showing a plating apparatus which performs processes of one embodiment according to the present invention.

FIG. 3 is a side view showing a plating apparatus of one embodiment according to the present invention.

FIG. 4 is a side view showing another example of a plating apparatus of one embodiment according to the present invention.

FIGS. 5A and 5B are diagrams showing another example of a plating apparatus of another embodiment according to the present invention, and FIGS. 5A and 5B are a perspective view and a side view of a roller.

FIG. 6 is a flow chart showing a production processes for separator of the embodiments according to the present invention.

### DESCRIPTION OF THE PREFERRED EMBODIMENTS

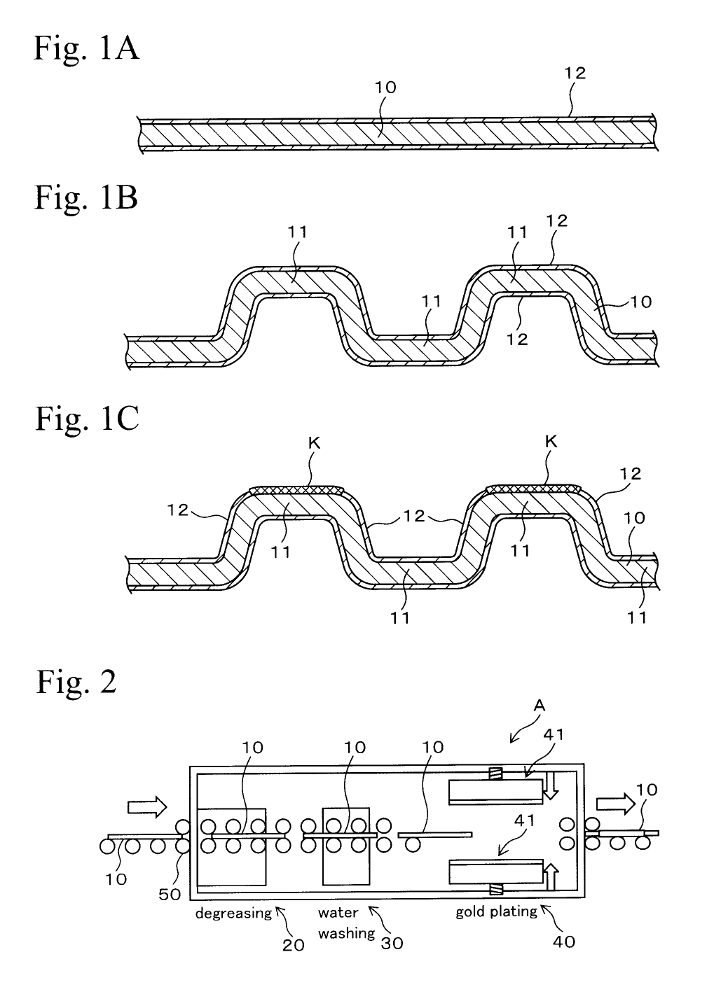

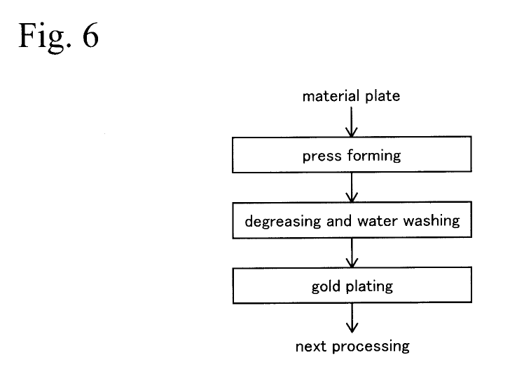

One embodiment of the present invention will be described hereinafter with reference to Figures. FIGS. 1A to 1C are diagrams showing a production method for a fuel cell separator of the embodiment. FIG. 2 is a diagram showing a plating apparatus A which performs the production method. As shown in FIG. 6, main processes performed in this production method are press forming and gold plating. Each process will be explained in turn hereinafter.

### 1. Press Forming

The press forming is a process that a material plate 10 is formed by press forming so as to have a cross section (corrugated cross section) having a concavo-convex shape. As shown in FIG. 1A, a thin plate made of stainless steel (for example, stainless steel SUS304 of the Japanese Industrial Standards (=JIS)), which is cut to have a desired length, is used as the material plate 10. The material plate 10 is subjected to press forming, and predetermined portions of the material plate 10 are formed so as to have a cross section having a concavo-convex shape shown in FIG. 1B. Thus, the material plate 10 has convexes 11 formed by the press forming.

Next, respective processes after the press forming are performed by the plating apparatus A shown in FIG. 2. In the plating apparatus A, a degreasing stage 20, a water washing 30, and a gold plating stage 40 are provided in turn from an upper stream to a lower stream, and the material plate 10 is carried by a roller conveyer 50 and the material plate 10 is subjected to processing at each stage.

### 2. Degreasing and Water Washing

In the degreasing, for example, at the degreasing stage 20, a strong alkaline degreasing agent contacts the material plate 10, and grease adhered to a surface of the material plate 10 is removed. In the water washing, at the water washing stage 30, water is injected and showered onto the material plate 10.

### 3. Gold Plating

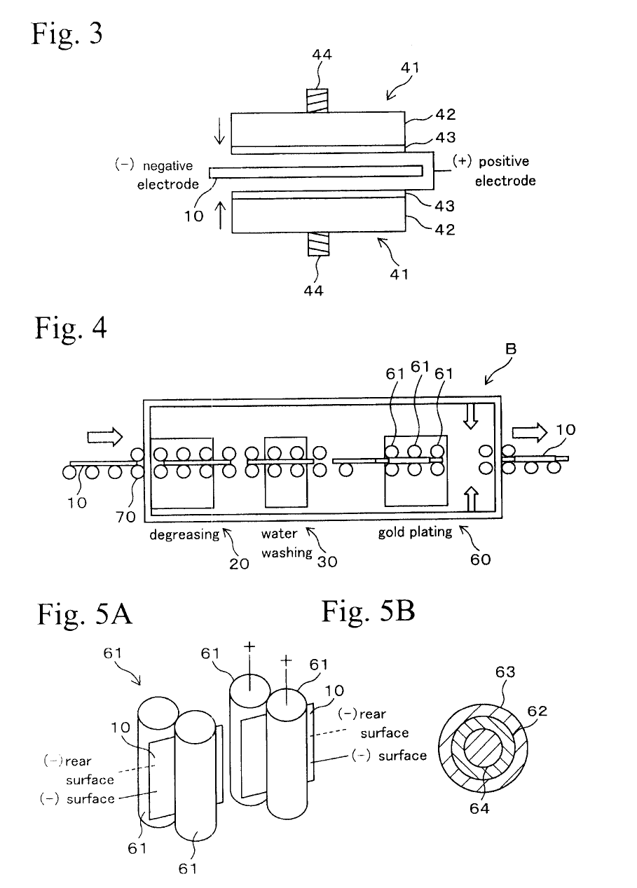

The gold plating is a process that the passivation film formed on surfaces of the convexes 11 of the material plate 10 is removed, and gold coating K is formed thereat by gold plating. FIG. 3 schematically shows a stamp 41 provided on the gold plating stage 40. The stamp 41 is structured such that a porous material 43 is provided on a surface of a flat plate 42 made of a conductive material, and a shaft 44 is fixed to a center portion of the flat plate 42.

Carbon, Ti—Pt alloy, Ti—Au alloy, a material in which Ir₂O₃, or the like is dispersed in Ti or the like is used as a material of the flat plate 42. Cloth, sponge, rubber, or the like is used as a material of the porous material 43. Urethane or polyvinyl alcohol (PVA) is used as a material of the sponge. A device (not shown in the Figures) which supplies the plating solution to the porous material 43 is provided. The stamps 41 close to each other so as to hold the convexes 11 of the material plate 10. In this condition, direct current is supplied such that the convexes 11 function as negative electrodes, and the stamps 41 function as positive electrodes.

For example, potassium gold cyanide solution is used as the plating solution, the plating solution has a density of Au (gold) which is 10 to 30 g/L, and the current density is 0.75 to 1.5 A/dm². These conditions are used for strike plating. In an electrolytic system having the flat plate 42, the plating solution, and the material plate 10, electrolysis of water occurs, and hydrogen is generated on the surfaces of the convexes 11 which function negative electrodes. In this case, hydrogen ion contacts the convexes 11, the passivation film 12 is thereby reduced, and gold coating K is deposited at the portion at which the passivation film is removed by the reduction. Thickness of the gold coating K formed by the gold plating on the material plate 10 is not limited in particular. When use amount of gold is reduced and economics is considered, the thickness of the gold coating K is about 20 to 100 nm. After the gold plating, water washing for washing of the plating solution can be performed, and drying can be performed.

FIGS. 4 and 5 are diagrams which show another embodiment according to the present invention. A plating apparatus B of this embodiment has rollers 61 used for a gold plating stage 60, and this use of the rollers 61 is different from the above embodiment explained by using FIGS. 2 and 3. As schematically shown in FIG. 5B, the roller 61 is structured such that a porous material 63 is provided at a periphery of a roll 62 made of a conductive material, and a rotary shaft 64 is fixed at a center portion of the roll 62.

Carbon, Ti—Pt alloy, Ti—Au alloy, a material in which Ir₂O₃ is dispersed in Ti, or the like is used as a material of the roll 62. Cloth, sponge, rubber, or the like is used as a material of the porous material 63. Urethane or polyvinyl alcohol (PVA) is used as a material of the sponge. A device (not shown in the Figures) which supplies the plating solution to the porous material 63 is provided. The rollers 61 hold the convexes 11 of the material plate 10. In this condition, direct current is supplied such that the convexes 11 function as negative electrodes, and the rollers 61 function as positive electrodes.

The material plate 10, which is disposed in a lateral condition (in which the rectangular shape thereof is parallel to a horizontal direction), can be transferred to the all stages of the plating apparatus B and processed thereon. However, when the material plate 10, which is disposed in the lateral condition, is subjected to gold plating, the plating solution may be easily accumulated on an upper surface of the material plate 10. Due to this, the upper surface may be different from and the lower surface in quality of the gold coating. However, when only the convexes on one surface of the material plate 10 is subjected to gold plating, the above quality difference may not be generated.

In order not to generate the above quality difference, before the material plate 10 is transferred to the gold plating stage 60, the material plate 10 is rotated by 90 degrees so as to be disposed in a vertical condition (in which the rectangular shape thereof is parallel to a vertical direction). As shown in FIG. 5A, the material plate 10, which is disposed in a vertical condition, is subjected to gold plating. As shown in FIG. 5A, the rollers 61 hold the convexes 11 of the material plate 10. In this condition, direct current is supplied such that the convexes 11 function as negative electrodes, and the rollers 61 function as positive electrodes. In the above embodiment explained by using FIGS. 2 and 3, the material plate 10, which can be also disposed in the vertical condition, can be subjected to gold plating.

### EXAMPLES

A stainless steel plate of SUS304 of JIS having a thickness of 0.1 mm was subjected to press forming, so that a material plate was obtained. In this case, the material plate had a rectangle shape in planar view, and had a center portion having a concavo-convex shape cross section (corrugated cross section) shown in FIG. 1B. Next, as shown in FIG. 6, degreasing, water washing and gold plating were performed on the material plate in turn. In the gold plating, potassium cyanide solution having a density of Au which was 10 g/L was supplied to the porous material 43 of the stamp 41 shown in FIG. 3. Direct current was supplied to the material plate and the flat plate 42 (shown in FIG. 3) for ten minutes, and the current density was 1.5 A/dm².

The material plate after the gold plating was studied. As a result, it was conformed that coating did not almost exist at a portion other than the convexes of the material plate, and gold coating was selectively formed at the convexes of the material plate.

### INDUSTRIAL APPLICABILITY

According to the present invention, a conductive metal coating can be formed at only portions of separator which require conductivity without removal of passivation film. Thus, the present invention is greatly desirably used as a production method for inexpensive fuel cells.

What is claimed is:

1. A production method for fuel cell separator, comprising:
preparing a material plate made of stainless steel;
press forming the material plate, so that the material plate has a cross section having a concavo-convex shape; and
plating only convex of the concavo-convex shape of the material plate with a conductive metal, wherein
in the plating, a plating solution holding member, having a plating solution including an ion of the conductive metal, is prepared, the plating solution holding member contacts only the convex, and current is supplied between the solution holding member and the material plate, and
in the plating, hydrogen is generated on a surface of the material plate, a passivation film formed on the surface of the material plate is reduced by the hydrogen, and the material plate is plated with the conductive metal.
